(19) United States
(12) Patent Application Publication
(10) Pub. No.: US 2023/0274061 A1
(43) Pub. Date: Aug. 31, 2023

(54) METHOD AND SYSTEM FOR MODELING, SIMULATING AND OPTIMIZING FINFET DEVICE BASED ON SELF-HEATING EFFECT

(71) Applicant: SOUTH CHINA UNIVERSITY OF TECHNOLOGY, Guangdong (CN)

(72) Inventors: Bin LI, Guangdong (CN); Dan LU, Guangdong (CN); Zhaohui WU, Guangdong (CN)

(73) Assignee: SOUTH CHINA UNIVERSITY OF TECHNOLOGY, Guangdong (CN)

(21) Appl. No.: 17/601,432

(22) PCT Filed: Jul. 9, 2021
(86) PCT No.: PCT/CN2021/105479

§ 371 Date: Oct. 5, 2021

(51) Int. Cl. G06F 30/36

(52) U.S. Cl. CPC G06F 30/36; G06F 2119/08

(57) ABSTRACT

A method and system for modeling, simulating, and optimizing a FinFET device based on self-heating effect are provided. The method includes: building and electrically simulating a FinFET device model based on general data through simulation software; thermally simulating the FinFET device model to obtain a thermal parameter; modifying a simulated ambient temperature according to the thermal parameter and modifying the electrical characteristic parameter of the FinFET device model in an environment where a FinFET device is affected by self-heating; and finally building the FinFET device model based on self-heating effect. The method and system for modeling, simulating, and optimizing the FinFET device based on self-heating effect in disclosure provides lowered errors of device simulation, improved modeling precision, and enhanced accuracy of reliability analyses when being compared with conventional modeling without considering the self-heating effect.

### TECHNICAL FIELD

The disclosure relates to an advanced semiconductor device modeling and simulating technology, and in particular, relates to a method and system for modeling, simulating, and optimizing a FinFET device.

### DESCRIPTION OF RELATED ART

With the development of semiconductor device technology, the feature size of semiconductor devices has entered the deep nanometer node, and the short channel effect of conventional planar structure MOSFET devices considerably limits the development of Moore's Law. In 2001, professor Chenming Hu of the University of California, Berkeley proposed a three-dimensional structure of double-gate transistors, namely FinFET (fin field effect transistor) devices. The channel, source end and drain end protrude from the substrate, and the channel area is wrapped by the gate, forming three sides that are in contact with the gate and are controlled. The fin of the protruding part is fin-shaped, and therefore, it is called a fin-type field effect transistor.

The research of semiconductor device modeling is mature, and three modeling methods have been developed, namely, the physical model modeling method, the table look-up model modeling method, and the equivalent circuit model method. Among them, the physical model modeling method uses device simulation software for modeling most of the time. At present, the feature size of FinFET has reached the deep nanometer node. Using FinFET devices below 22 nm to perform reliability analysis is too costly and the cycle is excessively long, so it is necessary to use a software platform to simulate and analyze the reliability of FinFET devices.

The small channel size of the FinFET device causes significant phonon-boundary scattering. Further, FinFET devices have low thermal conductivity, poor heat dissipation efficiency, and high current density, causing the channel temperature of the FinFET devices to rise and causing the threshold voltage and saturation current to drift. The conventional FinFET device modeling ignores this self-heating effect, so that when the I-V electrical characteristic curve is corrected, deviations occur. Therefore, there is an urgent need for a method and system for modeling, simulating, and optimizing FinFET device based on self-heating effect.

### SUMMARY

The disclosure aims to provide a method and system for modeling, simulating, and optimizing a FinFET device based on self-heating effect to solve the above existing technical problems.

In the first aspect, the disclosure provides a method for modeling, simulating, and optimizing a FinFET device based on self-heating effect, and the method includes the following steps.

A FinFET device model is built based on general data through simulation software.

The FinFET device model is electrically simulated to obtain an electrical characteristic parameter.

The FinFET device model is thermally simulated to obtain a thermal parameter.

A simulated ambient temperature is modified according to the thermal parameter, and the electrical characteristic parameter of the FinFET device model is modified in an environment where a FinFET device is affected by self-heating.

The foregoing steps are repeated to optimize the electrical characteristic parameter of the FinFET device model until an electrical index curve is fitted.

Further, according to the general data, the FinFET device model is built through the simulation software. The general data includes: a channel length, a fin height, a fin width, a fin pitch, and a gate pitch of the FinFET device.

Further, the FinFET device model is electrically simulated to obtain a preliminarily-calibrated I-V electrical characteristic curve.

Further, the FinFET device model is thermal simulated to obtain a channel average temperature of the FinFET device model.

Further, the ambient temperature of the FinFET device model is modified and electrical simulation is performed, and a doping concentration, a concentration diffusion coefficient, and grid precision, a step length, and size parameter are accordingly modified, calculated, and fine-tuned. The FinFET device model is optimized and adjusted.

Further, the FinFET device model based on self-heating effect is built.

In the second aspect, the disclosure provides a system for modeling, simulating, and optimizing a FinFET device based on self-heating effect.

The system includes a model building module configured for building a FinFET device model based on general data of a FinFET device and optimizing the FinFET device model according to an electrical characteristic parameter or a thermal parameter.

The system further includes an electrical simulation module configured for electrically simulating the FinFET device model to obtain the electrical characteristic parameter.

The system further includes a thermal simulation module configured for thermodynamically simulating the FinFET device model and obtaining the thermal parameter of the FinFET device model.

Further, an electron current density \vec{Jₙ₁} and an electron hole current density \vec{Jₚ₁} of the FinFET device model are simulated through the electrical simulation module to obtain an I-V electrical characteristic curve of the FinFET device model.

In the method and system for modeling, simulating, and optimizing the FinFET device based on self-heating effect provided by the disclosure, based on the general data, the FinFET device model is built through the simulation software. The FinFET device model is electrically simulated to obtain the electrical characteristic parameter, and the FinFET device model is further thermally simulated to obtain the thermal parameter. Further, the simulated ambient temperature is modified according to the thermal parameter, and the electrical characteristic parameter of the FinFET device model is modified in the environment where the FinFET device is affected by self-heating. The FinFET device model based on self-heating effect is finally built. In the disclosure, the FinFET device is modeled, simulated, and optimized based on the self-heating effect, and therefore, when being compared with conventional modeling without considering the self-heating effect, errors of FinFET device simulation are reduced, precision of modeling is improved, and accuracy of reliability analyses is enhanced.

### BRIEF DESCRIPTION OF THE DRAWINGS

FIG. 1 is a flow chart of a method for modeling, simulating, and optimizing a FinFET device based on self-heating effect provided by the disclosure.

FIG. 2 is a graph comparing between a simulation I-V electrical characteristic curve of a FinFET device model based on self-heating effect and an experiment data curve provided by the disclosure.

### DESCRIPTION OF THE EMBODIMENTS

In order to make the objectives, technical solutions, and advantages of the disclosure clearer, the technical solutions of the disclosure are fully described below through specific implementations together with the accompanying drawings in the embodiments of the disclosure. Based on the embodiments of the disclosure, all other embodiments obtained by a person having ordinary skill in the art without making any creative work shall fall within the protection scope of the disclosure.

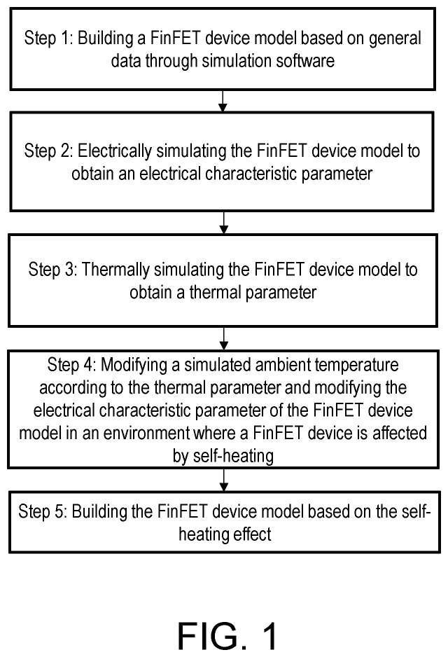

As shown in FIG. 1, the disclosure provides a method and system for modeling, simulating, and optimizing a FinFET device based on self-heating effect, and the method includes the following steps.

Step 1: A FinFET device model is built based on general data through simulation software.

Step 2: The FinFET device model is electrically simulated to obtain an electrical characteristic parameter.

Step 3: The FinFET device model is thermally simulated to obtain a thermal parameter.

Step 4: A simulated ambient temperature is modified according to the thermal parameter, and the electrical characteristic parameter of the FinFET device model is modified in an environment where a FinFET device is affected by self-heating.

Step 5: The FinFET device model based on self-heating effect is built.

In step 1, the general data are the key size parameters of the 7 nm FinFET device, which are specifically as follows: a channel length is 16 nm, a fin height is 32 nm, a fin width is 6 nm, a fin pitch is 30 nm, and a gate pitch is 56 nm.

The simulation software is Sentaurus TCAD. In the disclosure, Sentaurus TCAD simulation software is used to model and simulate the process and physical characteristics of FinFET device.

In step 2, according to the FinFET device model, Drift-Diffusion is used to simulate an electron current density \vec{Jₙ₁} and an electron hole current density \vec{Jₚ₁} of the FinFET device model. An I-V electrical characteristic curve obtained through the simulation is calibrated with the related art, and the FinFET device model is preliminarily optimized. The electron current density \vec{Jₙ₁} and the electron hole current density \vec{Jₚ₁} are calculated through:

J̅ₙ̅₁̅=−nqμₙ∇Φₙ and

J̅ₚ̅₁̅=−nqμₚ∇Φₚ,

where μₙ is mobility of electrons, μₚ is mobility of electron holes, Φₙ is a quasi-Fermi potential of the electrons, and Φₚ is a quasi-Fermi potential of the electron holes in the formulas.

In step 3, an electron current density \vec{Jₙ₂} and an electron hole current density \vec{Jₚ₂} of the optimized FinFET device model are thermal simulated, an average temperature of a FinFET device model channel is extracted. The electron current density \vec{Jₙ₂} and the electron hole current density \vec{Jₚ₂} are calculated through:

J̅ₙ̅₂̅=−nqμₙ(∇Φₙ+Pₙ∇T) and

J̅ₚ̅₂̅=−nqμₚ(∇Φₚ+Pₚ∇T),

where Pₙ is thermoelectric power of electrons, and Pₚ is thermoelectric power of electron holes in the formulas.

In step 4, the simulated ambient temperature is modified according to the average temperature of the FinFET device model channel. The electrical simulation continues under the environment where the FinFET device is affected by self-heating, and a doping concentration, a concentration diffusion coefficient, and grid precision, a step length, and the size parameters are accordingly modified, calculated, and fine-tuned. The I-V electrical characteristic curve of the FinFET device model is then further modified.

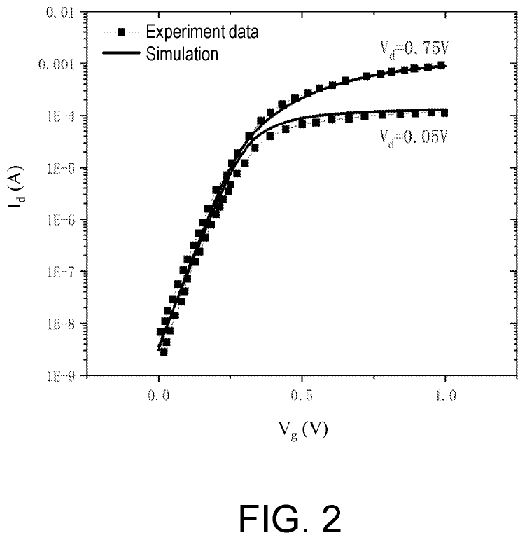

From the existing model, it can be seen that a subthreshold swing SS of the 7 nm FinFET device is 69 mV/dec, while the subthreshold swing SS the optimized FinFET device is 70.2 mV/dec, and a relative error between the two is 1.7%. As shown in FIG. 2, the drain current on the ordinate is processed logarithmically, and it can be seen that the simulated I-V electrical characteristic curve of the disclosure approximately fits the experiment data curve. In step 5, according to the electrical characteristic parameter of the FinFET device model, the FinFET device model based on self-heating effect is built. The electrical characteristic parameter includes a threshold voltage Vₜₕ and a saturation current Iₒₙ. When V_{d} is 0.05V, the threshold voltage Vₜₕ is 0.248V, and the saturation current Iₛₐₜ is 130.01 μA/μm, and when V_{d} is 0.75V, the threshold voltage Vₜₕ is 0.367V, and the saturation current Iₛₐₜ is 896.75 μA/μm.

In this embodiment of the disclosure, based on the general data, the FinFET device model is built with the aid of simulation software, and the I-V electrical characteristic curve thereof is preliminarily calibrated through electrical simulation, and the FinFET device model is further thermally simulated to obtain the thermal parameter. The simulated ambient temperature is modified according to this thermal parameter, and the electrical characteristic parameter of the FinFET device model in the environment where the FinFET device is affected by self-heating is modified. The FinFET device model based on self-heating effect is finally built, and in this way, errors of device simulation are reduced, precision of modeling is improved, and accuracy of reliability analyses is enhanced.

For a person having ordinary skill in the art, various other corresponding changes and deformations can be made based on the technical solutions and concepts described above, and all these improvements and deformations should fall within the protection scope of the claims of the disclosure.

1. A method for modeling, simulating, and optimizing a FinFET device based on self-heating effect, comprising:
building a FinFET device model based on general data;
electrically simulating the FinFET device model to obtain an electrical characteristic parameter;
thermally simulating the FinFET device model to obtain a thermal parameter; and
modifying a simulated ambient temperature according to the thermal parameter and modifying the electrical characteristic parameter of the FinFET device model in an environment where a FinFET device is affected by self-heating.

2. The method for modeling, simulating, and optimizing the FinFET device based on the self-heating effect according to claim 1, wherein the step of building the FinFET device model further comprises the following step:
building the FinFET device model according to the general data through simulation software, wherein the general data comprises: a channel length, a fin height, a fin width, a fin pitch, and a gate pitch of the FinFET device.

3. The method for modeling, simulating, and optimizing the FinFET device based on the self-heating effect according to claim 1, wherein in the electrical simulation, the simulation software is used to simulate a first electron current density \vec{Jₙ₁} and a first electron hole current density \vec{Jₚ₁} of the FinFET device model to obtain the electrical characteristic parameter, and the FinFET device model is optimized according to the electrical characteristic parameter, wherein the first electron current density \vec{Jₙ₁} and the first electron hole current density \vec{Jₚ₁} are calculated through:
J̅ₙ̅₁̅=−nqμₙ∇Φₙ and
J̅ₚ̅₁̅=−nqμₚ∇Φₚ,
wherein μₙ is mobility of electrons, μₚ is mobility of electron holes, Φₙ is a quasi-Fermi potential of the electrons, and Φₚ is a quasi-Fermi potential of the electron holes in the formulas.

4. The method for modeling, simulating, and optimizing the FinFET device based on the self-heating effect according to claim 3, wherein a second electron current density \vec{Jₙ₂} and a second electron hole current density \vec{Jₚ₂} of the optimized FinFET device model are thermal simulated, wherein the second electron current density \vec{Jₙ₂} and the second electron hole current density \vec{Jₚ₂} are calculated through:
J̅ₙ̅₂̅=−nqμₙ(∇Φₙ+Pₙ∇T) and
J̅ₚ̅₂̅=−nqμₚ(∇Φₚ+Pₚ∇T),
wherein Pₙ is thermoelectric power of electrons, and Pₚ is thermoelectric power of electron holes in the formulas.

5. The method for modeling, simulating, and optimizing the FinFET device based on the self-heating effect according to claim 4, wherein in the thermal simulation, the obtained thermal parameter of the FinFET device model is a channel average temperature.

6. The method for modeling, simulating, and optimizing the FinFET device based on the self-heating effect according to claim 5, wherein the simulated ambient temperature is modified according to the thermal parameter, a real working state of the FinFET device is simulated, the FinFET device model is electrical simulated again, and the electrical characteristic parameter of the FinFET device model is modified in the environment where the FinFET device is affected by self-heating.

7. The method for modeling, simulating, and optimizing the FinFET device based on the self-heating effect according to claim 6, wherein the step of modifying the electrical characteristic parameter further comprises the following step:
calibrating a standard electrical parameter, modifying a doping concentration and a concentration diffusion coefficient, modifying grid precision, and calculating a step length such that the electrical characteristic parameter of the FinFET device model is consistent with experiment data, wherein the electrical characteristic parameter comprises a threshold voltage Vₜₕ and a saturation current Iₒₙ.

8. The method for modeling, simulating, and optimizing the FinFET device based on the self-heating effect according to claim 7, wherein the FinFET device model based on the self-heating effect is built according to the calibrated electrical characteristic parameter of the FinFET device model.

9. A system for modeling, simulating, and optimizing a FinFET device based on self-heating effect, comprising:
a model building module, configured for building a FinFET device model based on general data of a FinFET device and optimizing the FinFET device model according to an electrical characteristic parameter or a thermal parameter;
an electrical simulation module, configured for electrically simulating the FinFET device model to obtain the electrical characteristic parameter; and
a thermal simulation module, configured for thermodynamically simulating the FinFET device model and obtaining the thermal parameter of the FinFET device model.

10. The system for modeling, simulating, and optimizing the FinFET device based on the self-heating effect according to claim 9, wherein a first electron current density \vec{Jₙ₁} and a first electron hole current density \vec{Jₚ₁} of the FinFET device model are simulated through the electrical simulation module to obtain the electrical characteristic parameter of the FinFET device model.
